(19) United States
(12) Patent Application Publication
(10) Pub. No.: US 2010/0178919 A1
(43) Pub. Date: Jul. 15, 2010

(54) OPTIMUM TECHNOLOGY SELECTION

(75) Inventors: Virat Deepak, San Diego, CA (US); Alex Kuang-Hsuan Tu, San Diego, CA (US); Parag Mohan Kanade, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/354,630

(22) Filed: Jan. 15, 2009

(51) Int. Cl. H04W 4/00

(52) U.S. Cl. 455/435.2

(57) ABSTRACT

Systems and methodologies are described that facilitate optimum technology selection within multi-modal configurations. A multi-mode mobile device can select and/or utilize a particular technology, system and/or configuration to provide optimal quality of service (QOS) in terms of various characteristics. For instance, an optimum technology can be selected and employed for a service request based upon performance, cost, power consumption, interference levels, and the like. The multi-modal mobile device can obtain characteristics of a plurality of technologies during idle states. The characteristics can be analyzed in order to generate a QOS table that provides relative rankings of the plurality of technologies in terms of service request type and the obtained characteristics. The QOS table can be utilized to select an optimum technology upon initiation of a service request.

### BACKGROUND

I. Field

The following description relates generally to wireless communications, and more particularly to employing dynamic selection and/or switching of technologies to provide optimum quality of service.

II. Background

Wireless communication systems are widely deployed to provide various types of communication content such as, for example, voice, data, and so on. Typical wireless communication systems may be multiple-access systems capable of supporting communication with multiple users by sharing available system resources (e.g. bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP2, 3GPP long-term evolution (LTE), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

Wireless communication systems oftentimes employ one or more base stations that provide a coverage area. A typical base station can transmit multiple data streams for broadcast, multicast and/or unicast services, wherein a data stream may be a stream of data that can be of independent reception interest to an access terminal. An access terminal within the coverage area of such base station can be employed to receive one, more than one, or all the data streams carried by the composite stream. Likewise, an access terminal can transmit data to the base station or another access terminal.

MIMO systems commonly employ multiple (N_{T}) transmit antennas and multiple (N_{R}) receive antennas for data transmission. A MIMO channel formed by the N_{T} transmit and N_{R} receive antennas may be decomposed into N_{S} independent channels, which may be referred to as spatial channels, where N_{S}≦{N_{T}, N_{R}}. Each of the N_{S} independent channels corresponds to a dimension. Moreover, MIMO systems may provide improved performance (e.g., increased spectral efficiency, higher throughput and/or greater reliability) if the additional dimensionalities created by the multiple transmit and received antennas are utilized.

Mobile devices can be multi-mode. A multi-mode mobile device or user equipment can utilize a variety of different technologies, systems and/or configurations to enable wireless communications. In addition, multi-mode devices can be configured and deployed for utilization in disparate networks.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described related to techniques that provide optimum technology selection within multi-modal configurations. A multi-mode mobile device can select and/or utilize a particular technology, system and/or configuration to provide optimal quality of service (QOS) in terms of various characteristics. For instance, an optimum technology can be selected and employed for a service request based upon performance, cost, power consumption, interference levels, and the like. The multi-modal mobile device can obtain characteristics of a plurality of technologies during idle states. The characteristics can be analyzed in order to generate a QOS table that provides relative rankings of the plurality of technologies in terms of service request type and the obtained characteristics. The QOS table can be utilized to select an optimum technology upon initiation of a service request.

According to related aspects, a method that facilitates employment of an optimal technology on a multi-mode mobile device is provided. The method can comprise determining communication technologies available to the multi-mode mobile device. The method can also include obtaining a plurality of characteristics related to each available communication technology. Further, the method can include analyzing the obtained characteristics to generate a value associated with each available communication technology. In addition, the method can comprise ranking the available technologies based at least in part on the generated values.

Another aspect relates to an apparatus that facilitates switching wireless communication technologies. The apparatus can include a technology evaluator that generated a ranking of a plurality of available communication technologies based at least in part on an analysis of one or more characteristics of the technologies. The apparatus can also comprise a service ascertainment module that determines a service type associated with an incoming service request, wherein the service request includes a request to initiate a traffic session of a particular type. In addition, the apparatus can comprise a technology selector that chooses a technology from the plurality of technologies based at least in part on the determined service type and the generated ranking.

Yet another aspect relates to a wireless communications apparatus that facilitates switching communication technologies based upon service type. The wireless communications apparatus can include means for obtaining a plurality of characteristics for one or more available communication technologies. The wireless communications apparatus can also comprise means for generating an aggregate value for each available communication technology based at least in part on the obtained characteristics, service type and one or more criteria. Further, the wireless communications apparatus can include means for ranking available technologies according to the aggregate value for each technology. Moreover, the wireless communications apparatus can comprise means for selecting a technology from the ranking of technologies upon receipt of a service request. In addition, the wireless communications apparatus can include means for configuring a mobile device to operate according to the selected technology.

Still another aspect relates to a computer program product, which can have a computer-readable medium. The computer-readable medium can include code for causing at least one computer to ascertain wireless communication technologies available in a particular geographic area. The computer-readable medium can include code for causing the at least one computer to scan the available wireless communication technologies to obtain a plurality of characteristics related to each technology. Further, the computer-readable medium can comprise code for causing the at least one computer to analyze the obtained characteristics to generate a value associated with each available technology. In addition, the computer-readable medium can include code for causing the at least one computer organize the available technologies based at least in part on the generated values.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example communications apparatus for employment within a wireless communications environment in accordance with an aspect.

FIG. 3 is an illustration of an example communications apparatus that provides analysis on a plurality of technology characteristics.

FIG. 4 is an illustration of an example system that facilitates evaluating and selecting a technology from a plurality of technologies based in part on a service request and one or more criteria.

FIG. 5 is an illustration of example table that retains technology rankings indexed by service type in accordance with an aspect of the subject disclosure.

FIG. 6 is an illustration of an example methodology that facilitates generating a table that lists one or more technologies based upon a plurality of characteristics.

FIG. 7 an illustration of an example methodology that facilitates selection of an optimum technology based upon a table that ranks one or more technologies.

FIG. 8 is an illustration of an example methodology that facilitates initiation of a traffic session on an optimum technology in accordance with an aspect of the subject disclosure.

FIG. 9 is an illustration of an example system that facilitates evaluating and selecting an optimum technology from a plurality of technologies.

FIG. 10 is an illustration of an example system that facilitates employment of multi-mode devices in wireless communications.

FIG. 11 is an illustration of an example wireless network environment that can be employed in conjunction with the various systems and methods described herein.

FIG. 12 is an illustration of an example system that facilitates selection of an optimum technology.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, evolved Node B (eNode B or eNB), base transceiver station (BTS) or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication systems such as code division multiple access (CDMA), time division multiple access (TDMA), frequency division multiple access (FDMA), orthogonal frequency division multiple access (OFDMA), single carrier frequency domain multiplexing (SC-FDMA) and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2).

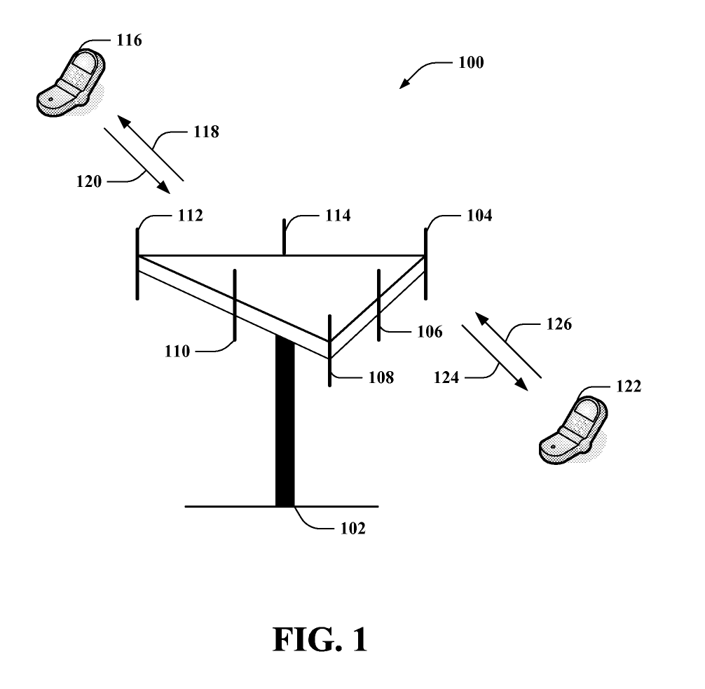

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. This can be provided by using a precoder to steer signals in desired directions, for example. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices. Moreover, mobile devices 116 and 122 can communicate directly with one another using a peer-to-peer or ad hoc technology in one example. According to an example, system 100 can be a multiple-input multiple-output (MIMO) communication system. Further, system 100 can utilize substantially any type of duplexing technique to divide communication channels (e.g., forward link, reverse link, . . . ) such as FDD, TDD, and the like.

Pursuant to an illustration, mobile devices 116 and 122 can be multi-mode devices capable of utilizing a variety of technologies or mechanisms to enable wireless communications via base station 102. For example, mobile devices 116 and 122 can employ technologies such as, but not limited to, Wi-Fi (e.g., IEEE 801.11), WiMAX (e.g., IEEE 802.16), CDMA and/or different CDMA codes, TDMA, FDMA, OFDMA, LTE, GSM, UMTS, UTRA, E-UTRA, CDMA2000, W-CDMA, UMB, Bluetooth, EV-DO, HSPA and the like. In addition, the mobile devices 116 and 122 can select or switch between the technologies to provide a user with optimum wireless communication access determined based upon a plurality of characteristics. To facilitate selection and/or switching, mobile device 116 and 122 can obtain characteristics associated with available technologies. The characteristics can be analyzed to evaluate and/or rank the available technologies. The rankings can be employed to enable utilization of an optimal technology in response to a service request.

In one example, mobile devices 116 and 122 can identify available technologies (e.g., networks, air interfaces, etc.) in a given location, such as a region inhabited by the mobile device 116 and 122. Mobile device 116 and 122 can obtain characteristics or qualities associated with the available technologies. The characteristics can be external to the mobile devices (e.g., interference levels experienced on a technology, costs, performance) and/or internal to the mobile devices (e.g., power consumption). The characteristics can be evaluated in order to rank the available technologies in terms of various criteria. For instance, the technologies can be ranked in terms of lowest cost, highest data rate, lowest power consumption, lowest interference, best-suited technology for a particular service, or combinations thereof. For example, several disparate rankings can be determined based upon each criteria individually and an aggregated ranking can be generated from the disparate rankings. In one illustration, the aggregated ranking can be a weighted average or sum of the disparate rankings. It is to be appreciated that a variety of statistical, analytical or intelligent mechanisms can be employed to generate the ranking of technologies. Mobile device 116 and 122 can initiate a service request to transmit and/or receive data or make calls. Mobile devices 116 and 122 can employ the generated rankings to select an optimum technology to utilize to initiate a session to serve the service request.

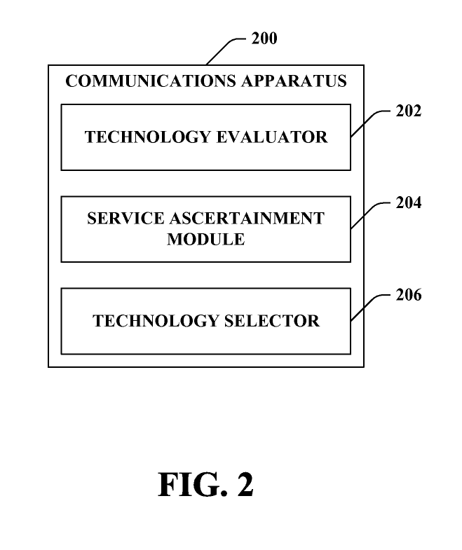

Turning to FIG. 2, illustrated is a communications apparatus 200 for employment within a wireless communications environment. The communications apparatus 200 can be a base station or a portion thereof, a mobile device or a portion thereof, or substantially any communications apparatus that receives data transmitted in a wireless communications environment. The communication apparatus 200 can be a multi-mode apparatus capable of employing a plurality of wireless communications technologies. Wireless communications technologies can include, without limitation, Wi-Fi (e.g., IEEE 801.11), WiMAX (e.g., IEEE 802.16), CDMA and/or different CDMA codes, TDMA, FDMA, OFDMA, LTE, GSM, UMTS, UTRA, E-UTRA, CDMA2000, W-CDMA, UMB, Bluetooth, EV-DO, HSPA and the like. It is to be appreciated that additional technologies that enable wireless communications can be employed.

The communications apparatus 200 can include a technology evaluator 202 that generates a ranking of available wireless communication technologies based upon a plurality of characteristics. In one aspect, the technology evaluator 202 can generate one or more rankings indexed according to service type. For instance, one ranking of technologies can be provided for voice service, another ranking for data service, and so on. The technology evaluator 202 can generate rankings of listings of technologies for a variety of service types such as, but not limited to, video on demand, audio streaming, media streaming, voice traffic (e.g., calls), Internet browsing, email, short message service (SMS), enhanced messaging service (EMS), multimedia messaging service (MMS), voice over IP (VoIP), and/or any other suitable data transfer service. In addition, it is to be appreciated that available wireless communication technologies can include substantially similar technologies offered by disparate wireless communications providers and/or operators, data providers, and the like.

The technology evaluator 202 generates values (e.g., rankings) of available wireless communication technologies based upon analysis of a plurality of characteristics. The characteristics can be external to the mobile devices (e.g., interference levels experienced on a technology, costs, performance) and/or internal to the mobile devices (e.g., power consumption). The characteristics can be evaluated in order to rank or provide a value to the available technologies in terms of various criteria. For instance, the technologies can be ranked in terms of lowest cost, highest data rate, lowest power consumption, lowest interference, best-suited technology for a particular service, or combinations thereof. For example, several disparate rankings can be determined based upon each criteria individually and an aggregated ranking can be generated from the disparate rankings. In one illustration, the aggregated ranking can be a weighted average or sum of the disparate rankings. It is to be appreciated that a variety of statistical, analytical or intelligent mechanisms can be employed to generate the ranking of technologies.

In another aspect, the technology evaluator 202 can maintain a table of values or rankings of available technologies. Upon receipt of a service request, the table can be queried to determine a technology to employ. Pursuant to an illustration, the communications apparatus 200 can include a service ascertainment module 204 that determines a type of service associated with a service request. As discussed supra, the type of service can be one or more types such as, but not limited, video on demand, audio streaming, media streaming, voice traffic (e.g., calls), Internet browsing, email, short message service (SMS), enhanced messaging service (EMS), multimedia messaging service (MMS), voice over IP (VoIP), and/or any other suitable data transfer service. When a type of service associated with a service request is determined, a technology selector 206 can query rankings generated by the technology evaluator 202 to ascertain at least a highest ranking technology associated with the determined service request type. The technology selector 206 can facilitate configuration of communications apparatus 200 to employ technologies, transition between technologies, enable technologies, disable technologies, and so on.

Pursuant to an example, communications apparatus 200 can idle on a particular technology. The communications apparatus 200 can be configured to operate with the particular technology or connected to an access point that provides access via the particular technology, but not have active data transfers. While idling, the technology evaluator 202 can evaluate available wireless communications technologies as described supra. Upon obtaining a service request, the service ascertainment module 204 can determine a type of service associated with the request. The technology selector 206 can determine a technology to employ for the service request based at least in part on type of service and the technology evaluator 202 evaluations. The communications apparatus 200 can be reconfigured to operate with the selected technology or connect to an access point providing access to the selected technology.

It is to be appreciated in the above described illustration that the communications apparatus 200 can employ the particular technology on which it is idling for the service request. In addition, it is to be appreciated that the communications apparatus 200 can be in an active state upon receiving a service request. For instance, the communications apparatus 200 can complete active transfers prior to a technology change, if a technology switch is desired. In addition, the communications apparatus 200 can utilize contention resolution mechanisms to schedule transfers on disparate technologies.

Moreover, although not shown, it is to be appreciated that communications apparatus 200 can include memory that retains instructions with respect to scanning for available technologies, evaluating available technologies, ranking available technologies, determining service types associated with requests, selecting technologies based upon evaluations, etc. Further, the memory can include instructions with respect to. Further, communications apparatus 200 can include a processor that may be utilized in connection with executing instructions (e.g., instructions retained within memory, instructions obtained from a disparate source, . . . ).

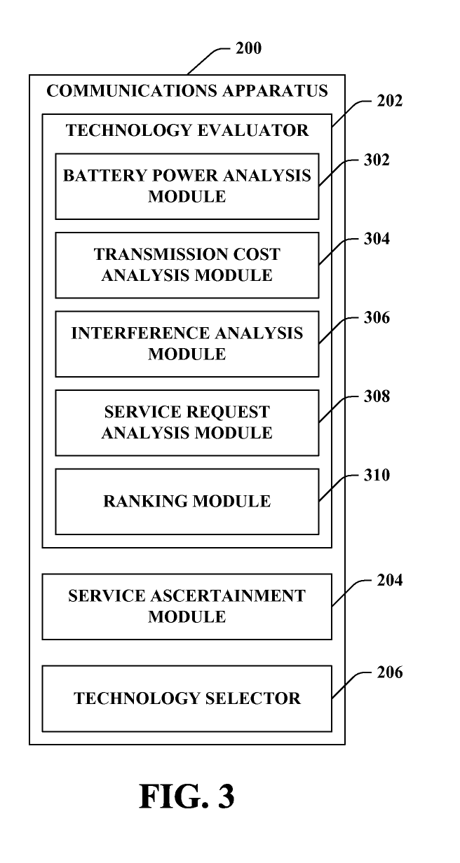

Turning to FIG. 3, illustrated is an example communications apparatus 200 that provides analysis of a plurality of technology characteristics. As described supra with respect to FIG. 2, communications apparatus 200 can be a multi-mode apparatus that can employ a variety of technologies to communicate wirelessly. The communications apparatus 200 can include a technology evaluator 202 that analyzes available technologies and generates rankings, a service ascertainment module 204 that determines a type of service associated with a particular service request and a technology selector 206 that facilitates configuration of the communications apparatus 200 to an appropriate technology selected based upon the rankings and service type. In addition, it is to be appreciated that technology evaluator 202, service ascertainment module 204, and technology selection 206 can be substantially similar and perform substantially similar functions as technology evaluator 202, service ascertainment module 204, and technology selection 206 described above with reference to FIG. 2.

The technology evaluator 202 generates values and rankings of available technologies based upon a plurality of characteristics and/or criteria. The characteristics can include factors such as, but not limited, to interference levels, costs, performance, power consumptions, etc. Moreover, the technology evaluator 202 can generate the values and ranking relative to service type. For instance, a value of each characteristic can be determined for each service type available. A service type can include video on demand, audio streaming, media streaming, voice traffic (e.g., calls), Internet browsing, email, short message service (SMS), enhanced messaging service (EMS), multimedia messaging service (MMS), voice over IP (VoIP), and/or any other suitable data transfer service.

Pursuant to an illustration, the technology evaluator 202 can include a battery power analysis module 302 that evaluates available technology based upon power consumption. The battery power analysis module 302 can consider current power level (e.g., battery level remaining) and/or amount of power consumed to satisfy a service request (e.g., transmit data, receive data, and the like). For example, the battery power analysis module 302 can generate a high value for a particular technology that is power conscientious. In addition, the battery power analysis module 302 can weight values in accordance with current power level. For instance, power consumption values can be weighted lower when the communications apparatus 200 is fully charged and/or weighted higher when the apparatus 200 is low on power.

The technology evaluator 202 can also include a transmission cost analysis module 304 that can evaluate available technologies in terms of cost to transmit a bit. According to an example, one technology (e.g., OFDMA) can have a higher cost to transmit a bit than another technology (e.g., WiFi) due to operator charges, service contracts, service areas, overages and the like. In addition, the values generated by the transmission cost analysis module 304 can be weighted based at least in part on transmission volume associated with various service types. For instance, video-on-demand services can typically include larger data amounts than SMS messages. In addition, the transmission cost analysis module 304 can consider various cost structures such as a per kilobyte charge (e.g, internet traffic) or a flat charge (e.g., SMS message).

The technology evaluator 202 can include an interference analysis module 306 that can ascertain interference levels associated with wireless communication technologies and value the technologies accordingly. For instance, the interference analysis module 306 can generate a lower value for a technology experiencing high levels of interference at a particular time. The technology evaluator 202 can also include a service request analysis module 308 that can evaluate and/or aggregate values provided by the battery power analysis module 302, the transmission cost analysis module 304 and the interference analysis module 306 in terms of service type. For instance, the service request analysis module 308 can generate a composite value for each service type. The composite value can include weightings for each parameter (e.g, battery power, transmission cost, interference analysis, etc.) that can be unique to each service type. For example, one service can be processor intensive and accordingly, power intensive. Accordingly, the service request analysis module 308 can weight batter consumption higher to provide greater consideration to technologies with conservative transmission power requirements. Pursuant to another illustration, the service request analysis module 308 can evaluate services for interference level tolerances and weight interference levels of technologies. The service request analysis module 308 can generate composite value for each available technology and for each service type.

The technology evaluator 202 can further include a ranking module 310 that can organize or sort composite values for each technology. The ranking module 310 can provide a numeral ranking of values (e.g., highest to lowest, lowest to highest, etc.) or rank according to other criteria. For example, the ranking module 310 can rank according to a goal such as, but not limited to, greatest power consumption, greatest transfer rate, most reliable transfer (e.g., lowest interference) and the like. The ranking module 310 can index the values by service type. In addition, the ranking module 310 can persist the indexed composite values in a table or other data structure. The technology evaluator 202 can periodically update the persisted table as necessary. For instance, the communications apparatus 200 can move into a new geographic area with different available technologies. In addition, the table can be updated during long idle periods to enable a current ranking of technologies upon receipt of a service request.

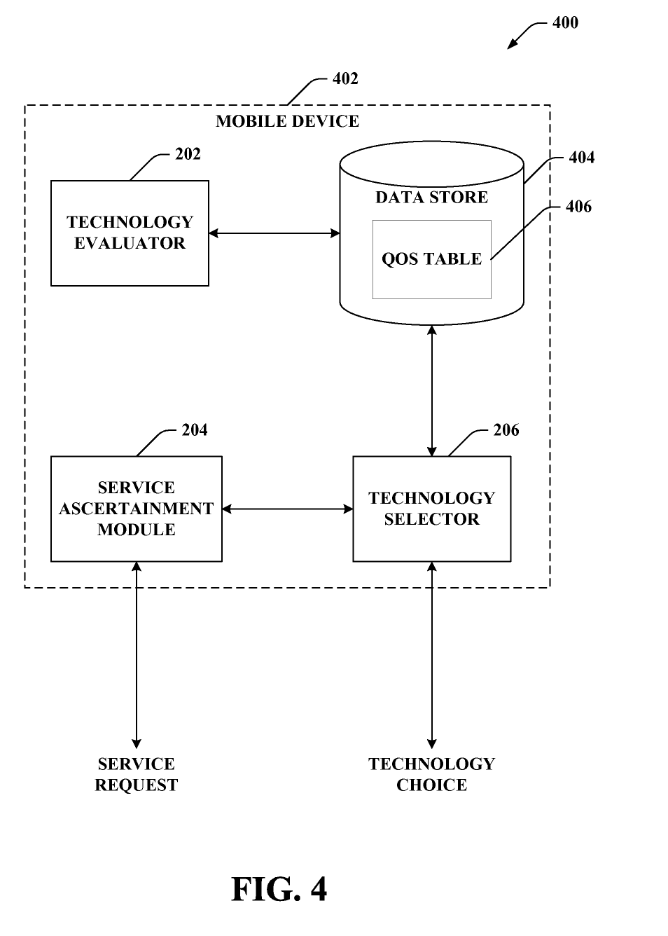

FIG. 4 depicts a system 400 that facilitates evaluating and selecting a technology from a plurality of technologies based in part on a service request and one or more criteria. The system 400 can include a mobile device 402. The mobile device 402 can communicate with a base station or access point (not shown) and/or any number of disparate devices. For instance, the mobile device 402 can receive information from a base station, access point or other provider over a forward link channel or downlink channel. Further, the mobile device 402 can transmit information to a base station or access point over a reverse link channel or uplink channel. Moreover, mobile device 402 can be a capable of operating in a MIMO system. Additionally, mobile device 402 can operate in an OFDMA wireless network. Additionally, the system 500 can operate in an OFDMA wireless network (such as 3GPP, 3GPP2, 3GPP LTE, etc., for example).

Mobile device 402 can include a technology evaluator 202 that analyzes available technologies in view of a plurality of characteristics to generate values to each technology for each service type. The mobile device 402 can also include a service ascertainment module 204 that obtains a service request and determines a service type associated therewith. Mobile device 402 can further include a technology selector 206 that generates a technology choice based upon the determined service type and evaluations by the technology evaluator 202. It is to be appreciated that technology evaluator 202, service ascertainment module 204 and technology 206 can be substantially similar and/or provide similar functionality as similarly numbered modules described supra with reference to FIGS. 2 and 3.

Mobile device 402 can include a data store 404 that retains a QOS table 406. The QOS table 406 can include values for available wireless communication technologies evaluated by the technology evaluator 202. In one example, the values can be indexed by service type to enable efficient querying of the QOS table for a technology based upon an ascertained type of an obtained service request.

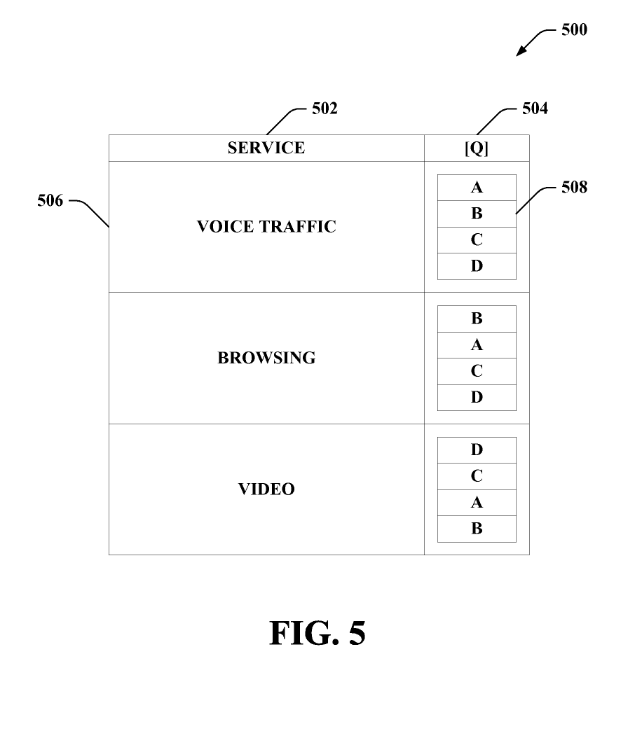

Turning briefly to FIG. 5, an example table 500 is illustrated. Table 500 can include QOS values and/or rankings of available wireless communication technologies similar to table 406 described with reference to FIG. 4. In addition, table 500 can be retained by data store 404. In an illustrative example, table 500 includes two columns wherein one column 502 specifies a service type and a second column 504 includes an array of technologies. Accordingly, each row includes a service type and an array of technologies ordered or ranked based upon a plurality of characteristics and/or criteria as described supra. For example, cell 506 of table 500 includes a service type of voice traffic. Corresponding to cell 506 is cell 508 that retains an array of technologies ranked based on characteristics specific to voice traffic. Similarly, other arrays are persisted for other service types (e.g., browsing, video, etc.). Since technologies rankings are specialized by service type and indexed by service type, an appropriate technology can be selected by querying table 500 with a service type to obtain the array of technologies. While table 500 depicts three service types and arrays of length four, it is to be appreciated that other service types can be included in the table the length of the array can be equivalent to number of available wireless communication technologies.

Returning to FIG. 4, technology selector 206 can query QOS table 406 with a service type determined by the service ascertainment module 204. The QOS table 406 can be similar to table 500 described above or can be structured according to a different schema that indexes by service type. The technology selector 206 can select a first technology or a top most technology from the array or ranking of technologies obtained from the QOS table 406. After selection of a technology, mobile device 402 can be reconfigured to employ the selected technology and commence satisfying the service request.

It is to be appreciated that the data store 404 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM. The data store 404 of the subject systems and methods is intended to comprise, without being limited to, these and any other suitable types of memory.

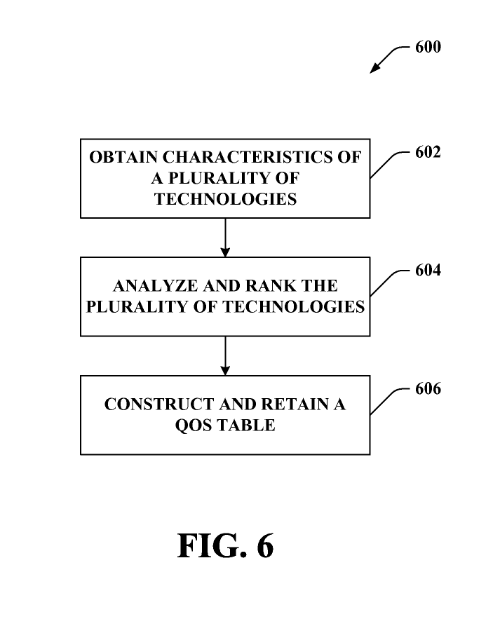

Referring to FIGS. 6-8, methodologies relating ranking available wireless technologies according to a plurality of characteristics are described. While for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 6, illustrated is a method 600 that facilitates generating a table that lists one or more technologies based upon a plurality of characteristics. In particular, the method 600 can be employed by a mobile device or other communications apparatus to evaluate and rank available wireless communication technologies. Available wireless communication technologies can include technologies that enable and implement wireless communications and include, without limitation, Wi-Fi (e.g., IEEE 801.11), WiMAX (e.g., IEEE 802.16), CDMA and/or different CDMA codes, TDMA, FDMA, OFDMA, LTE, GSM, UMTS, UTRA, E-UTRA, CDMA2000, W-CDMA, UMB, Bluetooth, EV-DO, HSPA and the like. A technology can be considered available if a multi-mode mobile device can utilize the technology in a particular area (e.g., a suitable technology provider is reachable). At reference numeral 602, characteristics of a plurality of technologies are obtained. The plurality of technologies can include available technologies in a particular area (e.g., geographic region). The characteristics can include characteristics external to the mobile devices (e.g., interference levels experienced on a technology, costs, performance) and/or internal to the mobile devices (e.g., power consumption). In addition, the characteristics for each technology of the plurality of technologies can be obtained for each service type that can be employed. For instance, service types can include video on demand, audio streaming, media streaming, voice traffic (e.g., calls), Internet browsing, email, short message service (SMS), enhanced messaging service (EMS), multimedia messaging service (MMS), voice over IP (VoIP), and/or any other suitable data transfer service. Characteristics of a technology can vary depending on service type. For example, battery consumption can be greater on a particular technology for video-on-demand service that for voice traffic on the same technology.

At reference numeral 604, the plurality of technologies can be analyzed and ranked based at least in part on the obtained characteristics. The plurality of technologies can be analyzed and ranked according to a variety of criteria. The criteria can provide a variety heuristics and/or weightings to apply to the characteristics to generate a desired ranking. For example, the criteria can correspond to goals such as lowest cost technology, highest data rate technology, highest signal-to-noise ratio technology, most power conservative technology and the like. The criteria employed can affect mechanisms utilized to combine obtained characteristics for each technology/service type pairing. For instance, differences in applied heuristics associated with the criteria selected can affect a composite value derived from the characteristics. The composite values of each technology/service type pairing can be ranked numerically or via some other suitable technique.

At reference numeral 606, a table can be constructed and retained. The table can include the rankings of technologies. In addition, the table can be indexed according to service type to enable efficient querying of relevant rankings of available technologies. For instance, the table can include each service type and an array of technologies ordered according to characteristics associated with the service type.

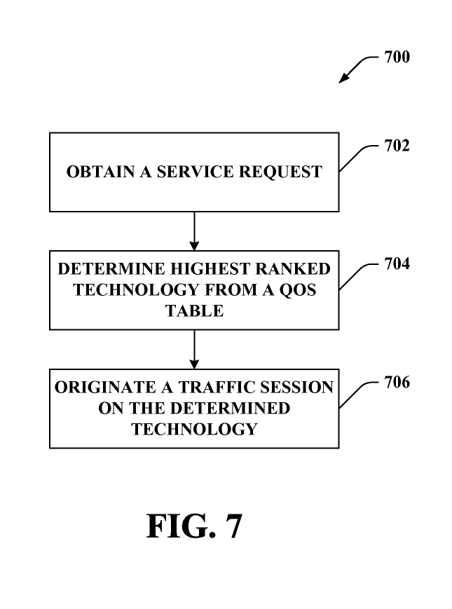

Referring now to FIG. 7, illustrated is a method 700 that facilitates selection of an optimum technology based upon a table that ranks one or more technologies. At reference numeral 702, a service request is obtained. The service request can be an input that indicates a desire to initiate a traffic session. The service request can be associated with a particular service type. At reference numeral 704, highest-ranking technology can be determined. Pursuant to an illustration, a table can be utilized for such determination. The utilized table can be substantially similar or retain similar information to tables described supra with respect to FIGS. 4, 5, and 6. In one example, the table can index ranked technologies by service type. The table can be queried with service type to obtain a ranking of technologies associated to a particular type. The rankings can be analyzed to determine an optimum (e.g., highest ranking) technology. At reference numeral 706, a traffic session can be originated with the optimum technology. A mobile device or other suitable communication apparatus employing method 700 can be reconfigured to operate according to the determined optimum technology. It is to be appreciated that the mobile device can already be configured to operate and/or connected to the optimum technology. In such instances, the traffic session can be originated without reconfiguration or reconnection.

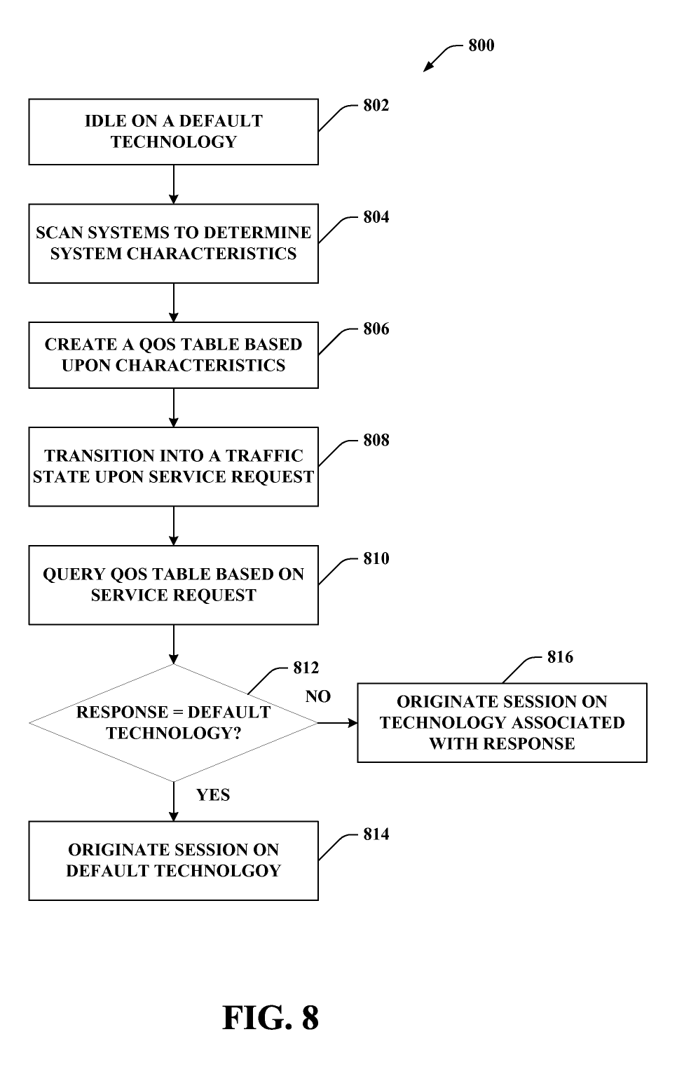

Turning now to FIG. 8, illustrated is a method 800 that facilitates initiation a traffic session on an optimum technology. Method 800 can be employed, for example, by a multi-mode mobile device capable of operating with a plurality of different communication technologies and/or different communication networks. At reference numeral 802, a default technology is idled upon. The default technology can be a pre-determined configuration, a configuration selected by preference, a configuration most often utilized and the like. In addition, the default technology idled upon can be a most recently employed technology.

At reference numeral 804, systems and/or available technologies are scanned to determine characteristics. Characteristics can include interference levels on technologies, cost to transmit a bit of data on a technology, power consumption during transmission and receiving on a technology, service types suited to a technology, and so on. At reference numeral 806, a table is created based upon the determined characteristics. In one example, the characteristics for each technology can be individually determined for each service type available. The characteristics can be analyzed to generate an aggregate value of a technology relative to a service type. The analysis can involve providing weights to different characteristics based upon requirements of service types and/or selected criteria or goals for ranking technologies (e.g., highest data rate, lowest power consumption, most reliable, etc.). The aggregate values for each technology relative to each service type can be ranked and indexed according to service type in the table.

At reference numeral 808, upon receipt of a service request, a transition into a traffic state occurs. To achieve an optimal tradeoff between performance, power consumption, cost, etc. or to achieve a selected criteria or goal, the technology employed for the service request can be reconfigured. At reference numeral 810, the table can be queried based on service request received. Pursuant to an illustration, the query can return an array or vector, Q, of ranked technologies such that the first element of the array or vector (e.g., Q[1]) corresponds to a highest ranked technologies. In addition, the query can return the highest ranked technology directly.

At reference numeral 812, a determination is made if the returned technology (e.g., highest ranked technology for a service type) is identical to the default technology. If the returned technology and default technology are identical, the method 800 proceeds to reference numeral 814 where a traffic session is originated on the default technology. If, at reference numeral 812, it is determined that the returned technology is not identical to the default technology, the method 800 proceeds to reference numeral 816. At 816, a traffic session is originated on the returned technology. For instance, a mobile device or other communication apparatus can be reconfigured to operate with the returned technology prior to initiation of the session.

It will be appreciated that, in accordance with one or more aspects described herein, inferences can be made regarding weighing characteristics, selecting ranking criteria, applying heuristics, transitioning technologies and the like. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

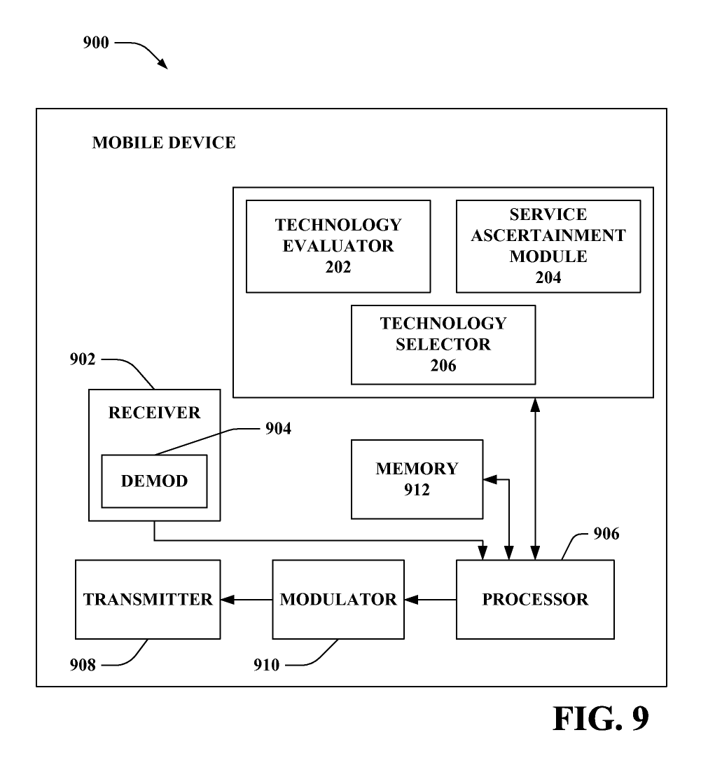

FIG. 9 is an illustration of a mobile device 900 that can facilitate communications associated with a mobile device in a wireless communication system in accordance with an aspect of the disclosed subject matter. It is to be appreciated that the mobile device 900 can be the same or similar as, and/or can comprise the same or similar functionality as, mobile device 116, mobile device 402 or communications apparatus 200, such as more described herein, for example, with regard to system 100, system 200, and system 400.

Mobile device 900 can comprise a receiver 902 that receives a signal from, for instance, a receive antenna (not shown), and performs typical actions thereon (e.g., filters, amplifies, downconverts, etc.) the received signal and digitizes the conditioned signal to obtain samples. Receiver 902 can be, for example, an MMSE receiver, and can comprise a demodulator 904 that can demodulate received symbols and provide them to a processor 906 for channel estimation. Processor 906 can be a processor dedicated to analyzing information received by receiver 902 and/or generating information for transmission by a transmitter 908, a processor that controls one or more components of mobile device 900, and/or a processor that both analyzes information received by receiver 902, generates information for transmission by transmitter 908, and controls one or more components of mobile device 900. Mobile device 900 can also comprise a modulator 910 that can work in conjunction with the transmitter 908 to facilitate transmitting signals (e.g., data) to, for instance, a base station (e.g., 102), another mobile device (e.g., 122), etc.

In one aspect, the processor 906 can be connected to a technology evaluator 202 that generates a ranking of available wireless communication technologies based upon a plurality of characteristics. In one example, the technology evaluator 202 can periodically update the rankings and retain the rankings in a table. In addition, the technology evaluator 202 can index the rankings by service type to enable efficient querying upon receiving a service request. In another aspect, the processor 906 can be coupled to a service ascertainment module 204 that determines a service type associated with a received service request. For instance, service requests can have types such as, but not limited to, video on demand, audio streaming, media streaming, voice traffic (e.g., calls), Internet browsing, email, short message service (SMS), enhanced messaging service (EMS), multimedia messaging service (MMS), voice over IP (VoIP), and/or any other suitable data transfer service. The processor 906 also can be connected to a technology selector 206 that can facilitate selection of an optimal technology based upon a determined service type and evaluated rankings.

Mobile device 900 can additionally comprise memory 912 that is operatively coupled to processor 906 and that can store data to be transmitted, received data, information related to available channels, data associated with analyzed signal and/or interference strength, information related to an assigned channel, power, rate, or the like, and any other suitable information for estimating a channel and communicating via the channel. Memory 912 can additionally store protocols and/or algorithms associated with estimating and/or utilizing a channel (e.g., performance based, capacity based, etc.). Further, memory 912 can retain tables or other data structures that include technology rankings generated from analysis of system characteristics.

It will be appreciated that the data store (e.g., memory 912) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 912 of the subject systems and methods is intended to comprise, without being limited to, these and any other suitable types of memory.

It is to be appreciated and understood that the technology evaluator 202, service ascertainment module 204, technology selector 206, and memory 912 each can be the same or similar as, or can comprise the same or similar functionality as, respective components such as more fully described herein, for example, with regard to system 200, system 300, and system 400. It is to be further appreciated and understood the technology evaluator 202, service ascertainment module 204, technology selector 206, and memory 912 each can be a stand-alone unit (as depicted), can be included within the processor 906, can be incorporated within another component, and/or virtually any suitable combination thereof, as desired.

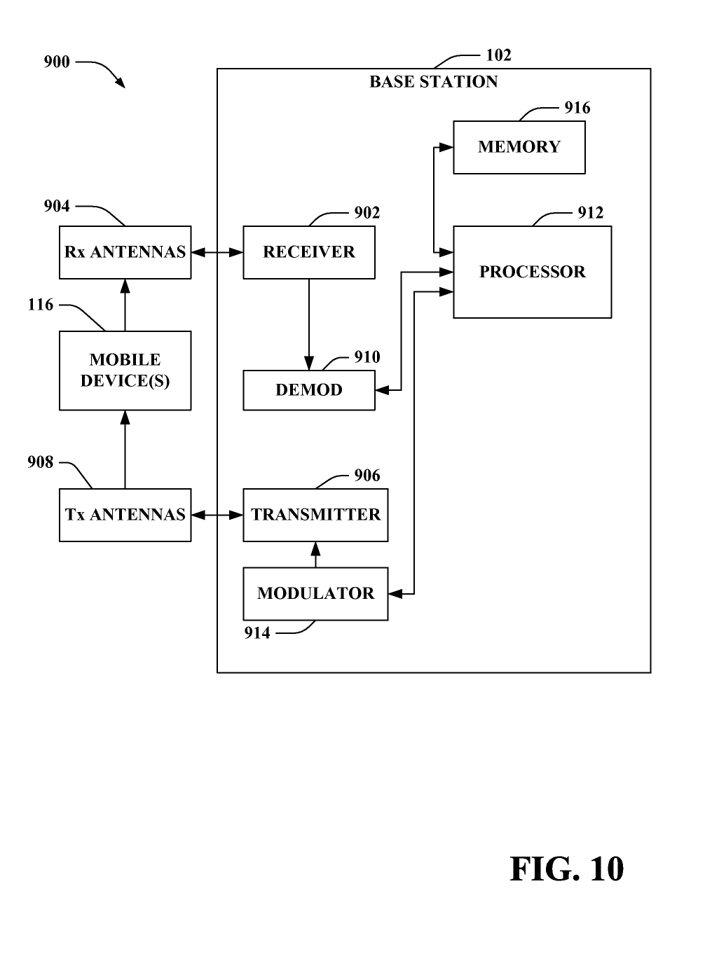

FIG. 10 is an illustration of a system 1000 that can facilitate communications associated with a mobile device in a wireless communication system in accordance with an aspect of the disclosed subject matter. System 1000 can comprise a base station 102 (e.g., access point, . . . ). The base station 102 can include a receiver 1002 that can receive signal(s) from one or more mobile devices 116 through a plurality of receive antennas 1004, and a transmitter 1006 that can transmit signals (e.g., data) to the one or more mobile devices 116 through a transmit antenna 1008. Receiver 1002 can receive information from receive antennas 1004 and can be operatively associated with a demodulator 1010 that can demodulate received information. Demodulated symbols can be analyzed by a processor 1012 that can be a processor dedicated to analyzing information received by receiver 1002 and/or generating information for transmission by a transmitter 1006, a processor that controls one or more components of base station 102, and/or a processor that both analyzes information received by receiver 1002, generates information for transmission by transmitter 1006, and controls one or more components of base station 102. The base station 102 can also comprise a modulator 1014 that can work in conjunction with the transmitter 1006 to facilitate transmitting signals (e.g., data) to, for instance, a mobile device 116, another device, etc.

Base station 102 can additionally comprise memory 1016 that is operatively coupled to processor 1012 and that can store data to be transmitted, received data, information related to available channels, data associated with analyzed signal and/or interference strength, information related to an assigned channel, power, rate, or the like, and any other suitable information for estimating a channel and communicating via the channel. Memory 1016 can additionally store protocols and/or algorithms associated with estimating and/or utilizing a channel (e.g., performance based, capacity based, etc.).

It will be appreciated that the memory 1016 described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1016 of the subject systems and methods is intended to comprise, without being limited to, these and any other suitable types of memory.

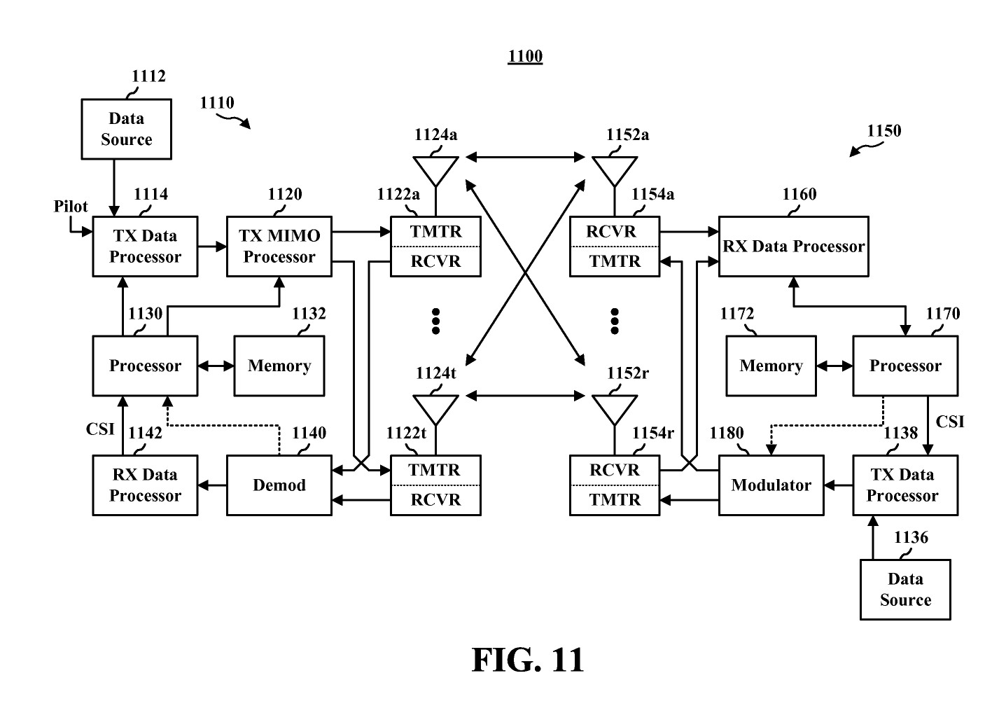

FIG. 11 shows an example wireless communication system 1100. The wireless communication system 1100 depicts one base station 1110 and one mobile device 1150 for sake of brevity. However, it is to be appreciated that system 1100 can include more than one base station and/or more than one mobile device, wherein additional base stations and/or mobile devices can be substantially similar or different from example base station 1110 and mobile device 1150 described below. In addition, it is to be appreciated that base station 1110 and/or mobile device 1150 can employ the systems (FIGS. 1, 2, 3, 4 and 9, 10 and 12), and/or methods (FIGS. 6-8) described herein to facilitate wireless communication there between.

At base station 1110, traffic data for a number of data streams is provided from a data source 1112 to a transmit (TX) data processor 1114. According to an example, each data stream can be transmitted over a respective antenna. TX data processor 1114 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1150 to estimate channel response. The multiplexed pilot and coded data for each data stream can be modulated (e.g. symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1130.

The modulation symbols for the data streams can be provided to a TX MIMO processor 1120, which can further process the modulation symbols (e.g., for OFDM). TX MIMO processor 1120 then provides NT modulation symbol streams to NT transmitters (TMTR) 1122a through 1122t. In various embodiments, TX MIMO processor 1120 applies beamforming weights to the symbols of the data streams and to the antenna from which the symbol is being transmitted.

Each transmitter 1122 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transmitters 1122a through 1122t are transmitted from N_{T} antennas 1124a through 1124t, respectively.

At mobile device 1150, the transmitted modulated signals are received by N_{R} antennas 1152a through 1152r and the received signal from each antenna 1152 is provided to a respective receiver (RCVR) 1154a through 1154r. Each receiver 1154 conditions (e.g., filters, amplifies, and downconverts) a respective signal, digitizes the conditioned signal to provide samples, and further processes the samples to provide a corresponding “received” symbol stream.

An RX data processor 1160 can receive and process the N_{R} received symbol streams from N_{R} receivers 1154 based on a particular receiver processing technique to provide N_{T} “detected” symbol streams. RX data processor 1160 can demodulate, deinterleave, and decode each detected symbol stream to recover the traffic data for the data stream. The processing by RX data processor 1160 is complementary to that performed by TX MIMO processor 1120 and TX data processor 1114 at base station 1110.

A processor 1170 can periodically determine which precoding matrix to utilize as discussed above. Further, processor 1170 can formulate a reverse link message comprising a matrix index portion and a rank value portion.

The reverse link message can comprise various types of information regarding the communication link and/or the received data stream. The reverse link message can be processed by a TX data processor 1138, which also receives traffic data for a number of data streams from a data source 1136, modulated by a modulator 1180, conditioned by transmitters 1154a through 1154r, and transmitted back to base station 1110.

At base station 1110, the modulated signals from mobile device 1150 are received by antennas 1124, conditioned by receivers 1122, demodulated by a demodulator 1140, and processed by a RX data processor 1142 to extract the reverse link message transmitted by mobile device 1150. Further, processor 1130 can process the extracted message to determine which precoding matrix to use for determining the beamforming weights.

Processors 1130 and 1170 can direct (e.g., control, coordinate, manage, etc.) operation at base station 1110 and mobile device 1150, respectively. Respective processors 1130 and 1170 can be associated with memory 1132 and 1172 that store program codes and data. Processors 1130 and 1170 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

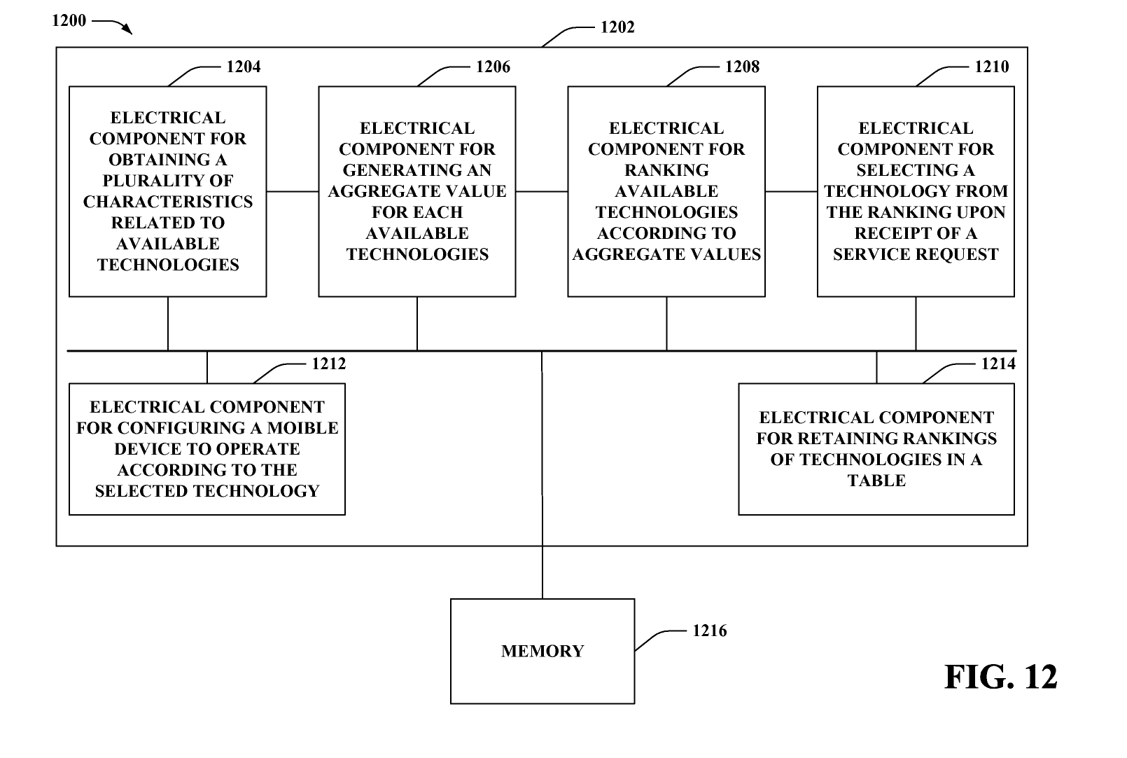

With reference to FIG. 12, illustrated is a system 1200 that facilitates selection of an optimum technology. For example, system 1200 can reside at least partially within a base station, mobile device, etc. It is to be appreciated that system 1200 is represented as including functional blocks, which can be functional blocks that represent functions implemented by a processor, software, or combination thereof (e.g., firmware). System 1200 includes a logical grouping 1202 of electrical components that can act in conjunction. For instance, logical grouping 1202 can include an electrical component for obtaining a plurality of characteristics related to available technologies 1204. For instance, the timer can be initiated and associated when the protocol data unit, generated based upon a data packet at a PDCP layer, arrives at a radio link control layer. Further, logical grouping 1202 can comprise an electrical component for generating an aggregate value for each available technologies 1206. Moreover, logical grouping 1202 can comprise an electrical component for ranking available technologies according to aggregate values 1208. Pursuant to an illustration, the data packet is discarded if the packet still resides at the packet data convergence protocol layer upon timer expiration. Logical grouping 1202 can comprise an electrical component for selecting a technology from the ranking upon receipt of a service request 1210. Further, logical grouping 1202 can include an electrical component for configuring a mobile device to operate according to the selected technology 1212. In addition, logical grouping 1202 can comprise an electrical component retaining rankings of technologies in a table 1214. Additionally, system 1200 can include a memory 1216 that retains instructions for executing functions associated with electrical components 1204, 1206, 1208, 1210, 1212 and 1214. While shown as being external to memory 1216, it is to be understood that one or more of electrical components 1204, 1206, 1208, 1210, 1212, and 1214 can exist within memory 1216.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that facilitates employment of an optimal technology on a multi-mode mobile device, comprising:
determining communication technologies available to the multi-mode mobile device;
obtaining a plurality of characteristics related to each available communication technology;
analyzing the obtained characteristics to generate a value associated with each available communication technology; and
ranking the available technologies based at least in part on the generated values.

2. The method of claim 1, further comprising retaining rankings of available technologies in a table indexed by service type.

3. The method of claim 2, further comprising:
receiving a service request, wherein the service request is associated with a particular service type;
querying the table of rankings with at least the particular service type associated with the service request; and
obtaining a highest ranked technology associated with the service type of the service request.

4. The method of claim 3, further comprising configuring the multi-mode mobile device to employ the highest ranked technology.

5. The method of claim 4, further comprising initiating a traffic session on the highest ranked technology to satisfy the service request.

6. The method of claim 1, wherein analyzing the obtained characteristics includes separately analyzing the characteristics for each available communication technology with respect to each service type accessible on the multi-mode mobile device.

7. The method of claim 1, wherein the generated value associated with each available technology includes an aggregation of the obtained characteristics, wherein the aggregation is determined according to one on more criteria.

8. The method of claim 7, wherein the one or more criteria include at least one of lowest power consumption, highest data rate, lowest interference or lowest transmission cost.

9. An apparatus that facilitates switching wireless communication technologies, comprising:
a technology evaluator that generated a ranking of a plurality of available communication technologies based at least in part on an analysis of one or more characteristics of the technologies;
a service ascertainment module that determines a service type associated with an incoming service request, wherein the service request includes a request to initiate a traffic session of a particular type; and
a technology selector that chooses a technology from the plurality of technologies based at least in part on the determined service type and the generated ranking.

10. The apparatus of claim 9, further comprising a power analysis module that evaluates available communication technologies based upon power consumption.

11. The apparatus of claim 9, further comprising a transmission cost analysis module that assesses available communication technologies according to cost to transmit at least one bit.

12. The apparatus of claim 9, further comprising an interference analysis module that ascertains interference levels experienced on the available wireless communications.

13. The apparatus of claim 9, further comprising a service request analysis module that evaluates the one or more characteristics of the technologies based at least in part on service types.

14. The apparatus of claim 13, wherein the service request analysis module generates a composite value for each service type from values associated with the one or more characteristics.

15. The apparatus of claim 13, further comprising a ranking module that sorts generated composite values for each service type.

16. The apparatus of claim 9, wherein the technology evaluator creates a table of rankings indexed according to service type such that each service type corresponds to a unique ranking.

17. A wireless communications apparatus that facilitates switching communication technologies based upon service type, comprising:
means for obtaining a plurality of characteristics for one or more available communication technologies;
means for generating an aggregate value for each available communication technology based at least in part on the obtained characteristics, service type and one or more criteria;
means for ranking available technologies according to the aggregate value for each technology;
means for selecting a technology from the ranking of technologies upon receipt of a service request; and
means for configuring a mobile device to operate according to the selected technology.

18. The wireless communications apparatus of claim 17, further comprising means for generating a table that retains rankings of technologies.

19. The wireless communications apparatus of claim 18, wherein the rankings of technologies are indexed according to service type.

20. The wireless communications apparatus of claim 17, wherein the plurality of characteristics include at least interference levels experienced on a technology, cost to transmit a bit on a technology, data rate of a technology, or power consumption to transmit and receive on a technology.

21. A computer program product, comprising:
a computer-readable medium comprising:
code for causing at least one computer to ascertain wireless communication technologies available in a particular geographic area;
code for causing the at least one computer to scan the available wireless communication technologies to obtain a plurality of characteristics related to each technology;
code for causing the at least one computer to analyze the obtained characteristics to generate a value associated with each available technology; and
code for causing the at least one computer organize the available technologies based at least in part on the generated values.

22. The computer program product of claim 21, wherein the computer-readable medium further comprises code for causing the at least one computer to retain a ranking of available technologies in table indexed by service type.

23. The computer program product of claim 22, the computer-readable medium further comprising:
code for causing the at least one computer to obtain a service request, wherein the service request is associated with a particular service type;
code for causing the at least one computer to query the table of rankings with at least the particular service type associated with the service request; and
code for causing the at least one computer to retrieve a highest ranked technology associated with the service type of the service request.

24. The computer program product of claim 23, wherein the computer-readable medium further comprises code for causing the at least one computer to configure a multi-mode mobile device to employ the highest ranked technology.

25. The computer program product of claim 24, wherein the computer-readable medium further comprises code for causing the at least one computer to initiate a traffic session on the highest ranked technology to satisfy the service request.
